(19) United States
(12) Patent Application Publication
(10) Pub. No.: US 2009/0132114 A1
(43) Pub. Date: May 21, 2009

(54) Control Device and Adjusting Mechanism of a Motor Vehicle

(75) Inventor: Mager Torsten, Schwalmtal (DE)

Correspondence Address: KING & SPALDING, 1185 AVENUE OF THE AMERICAS, NEW YORK, NY, 10036-4003, US

(73) Assignee: BROSE FAHRZEUGTEILE GMBH & CO KOMMANDITGESELLSCHAFT, COBURG, COBURG (DE)

(21) Appl. No.: 12/063,428

(22) PCT Filed: Jun. 12, 2006
(86) PCT No.: PCT/EP06/05590

§ 371 Date: Jul. 25, 2008

(30) Foreign Application Priority Data
Aug. 10, 2005 (DE) 20 2005 012 557.1

(51) Int. Cl. G06F 17/00

(52) U.S. Cl. 701/36

(57) ABSTRACT

The invention relates to a control device for an adjustment mechanism of a motor vehicle, wherein the control device includes an arithmetic unit that is configured to control a function unit of the motor vehicle, a volatile memory for storing control data, a non-volatile memory, and a circuit. The volatile memory is connected to the arithmetic unit for storing the control data, and the circuit is designed to transmit the control data from the volatile memory into the nonvolatile memory in a sleep mode or in a switched-off state of the arithmetic unit. The invention further relates to a method for controlling a functional unit of a motor vehicle.

### BACKGROUND OF THE INVENTION

EP 0 603 506 A2 discloses a method for determining the position of a part of motor vehicles which is driven in two directions by means of an electromotor. By using a counter, when the part moves in its two directions, counting pulses of a position signal transmitter are input into the counter in order to increase or decrease the counter reading in accordance with the predefined movement. After the drive motor switches off, the pulses supplied by the position signal transmitter are analyzed in their chronological distance from the switch-off time and are assigned to a further movement.

An arrangement for sensing the run-on of electrical actuator motors with incremental position sensing is known from DE 197 02 931 C1. An electronic evaluation system which detects the position signals of position signal transmitters is provided in DE 197 02 931 C1. The detected states of the position signals and the states of the position signal transmitters are stored in a nonvolatile memory. That is to say if all the system data is stored in this nonvolatile memory, the precondition for the electronic evaluation system to be temporarily disconnected from the supply voltage is met.

In order to sense run-on, the electronic evaluation system is provided with a buffer so that, even after the motor and the supply voltage have been switched off, the electronic evaluation system is still capable, for the time of the run-on, of both sensing the position during the run-on and of performing the provided data storage operation. The nonvolatile memory may be an EEPROM in the microcontroller of the electronic system. Furthermore, DE 197 02 931 C1 uses a buffer capacitor which serves to buffer the supply voltage of the electronic voltage system.

DE 43 15 637 C2, DE 197 33 581 C1 and DE 198 55 996 C1 each disclose a method for detecting the position and the direction of movement of a movably mounted part of a drive for adjustment devices in motor vehicles. The evaluation direction is determined from the signal edges of a single-channel sensor using an evaluation logic. In this context it is necessary to use the evaluation logic to determine whether the signal edges are to be assigned to the new direction of movement or the old direction of movement. DE 197 10 099 C2 and DE 29 22 160 C2 disclose window wiper devices which have a pulse transmitter for generating pulses as a function of the wiper movement. The pulses are counted by a counter. After the motor switches off, the pulses which occur up to the stationary state are counted and are used for further control.

DE 196 10 626 A1 discloses a means of sensing the run-on of electric adjustment motors in motor vehicles, which determines position signals of position signal transmitters during an undervoltage. The microcontroller for sensing the run-on is placed in an inactive operating state during the undervoltage between the sample times for sampling the position signals, in order to reduce the current drain from a buffer capacitor. The microcontroller here has a self-waking device, it being possible to place the microcontroller automatically back to the active operating state after a microcontroller time period which can be determined in advance. The microcontroller interrogates the position signals from position signal transmitters at specific sampling times. Furthermore, the microcontroller is placed in the inactive operating state between the necessary sampling times for a specific, calculated time period. The calculated time period is calculated starting from a detected signal edge change of the position signal.

In DE 101 30 183 B4, the position of the adjustment system is determined continuously as a function of a position signal in order to sense the position of an electric motor-driven adjustment system of a motor vehicle. The position signal is generated here by means of a signal transmitter/sensor arrangement. The run-on behavior of the adjustment system is determined during a dip in the supply voltage by virtue of the fact that, before the dip in the supply voltage, a speed characteristic variable is determined from a time dependence of the position signal, and after the dip in the supply voltage the position which is influenced by the run-on behavior is determined by the evaluation of the speed characteristic variable which was the current one before the dip.

In order to determine the run-on behavior without sufficient buffer capacitance it is necessary to evaluate information about the behavior of the window-lifting system just before the dip in the supply voltage after a voltage supply which is sufficiently high again. The position and the speed characteristic variable are stored at least temporarily on a continuous basis in a memory. For this purpose, at least the last value of the speed characteristic variable or the last average of the values of the speed characteristic variable is stored in the memory and read out again after the dip. As an alternative to nonvolatile memories such as EEPROM or FRAM it is also possible to use a simple RAM with a small capacitance in order to obtain the storage charge.

### SUMMARY OF THE INVENTION

The invention is based on the object of further developing a method and a device for controlling a drive of an adjustment device of a motor vehicle.

This object is achieved by means of a control device of a motor vehicle. Accordingly, a control device of a motor vehicle is provided. The control device is preferably designed to control an adjustment device of the motor vehicle such as an electromotively driven window lifter, an electromotively driven mirror, an electromotively driven sliding door, an electromotively driven tailgate or an electromotively driven seat.

The control device has an arithmetic unit which is configured to control a functional unit, in particular a drive motor of an adjustment device of the motor vehicle. The arithmetic unit is embodied, for example, as a microcontroller. In order to control the functional unit, the arithmetic unit is connected, for example by means of a driver, to power switches for energizing the drive motor.

Furthermore, the control device has a volatile memory for storing control data. In this context, a volatile memory loses the data stored in it as soon as a sufficient power supply is not available for this volatile memory. The control data serves to control the functional unit. The control data preferably has information about the determined position and preferably about the determined speed of the part of the functional unit to be adjusted, for example the position and speed of an electromotively adjustable window pane.

It is necessary in this context to store this control data at least temporarily for the purposes of control. In order to store, and advantageously read out, the control data, the arithmetic unit is connected to the volatile memory. An example of such a volatile memory is a read/write RAM (random access memory).

Furthermore, the control device has a nonvolatile memory. In contrast to the volatile memory, the nonvolatile memory does not lose the data stored in the nonvolatile memory if the power supply does not supply the nonvolatile memory. An example of such a nonvolatile memory is what is referred to as an EEPROM (Electrically-Erasable Programmable Read-Only Memory) or E²PROM.

In addition, the control device has a circuit which is different from the arithmetic unit. This circuit and/or the arithmetic unit are designed to place the arithmetic unit in a sleep mode and/or to switch off a power supply for the arithmetic unit. In both cases, the power consumption of the arithmetic unit is significantly reduced so that the arithmetic unit cannot carry out any operation, in particular cannot carry out a program run.

During this inactivity of the arithmetic unit, the circuit is at least temporarily independent of the arithmetic unit. In this context, the circuit is designed to transmit the control data from the volatile memory into the nonvolatile memory in the sleep mode of the arithmetic unit or in the switched-off state of the arithmetic unit. The transmission is advantageously conceived of here as a copying process. For the purpose of transmission, the circuit advantageously has a state generator (state machine) which generates a permanently defined sequence of functional steps of the transmission of the control data by means of its hardware. Owing to the definition by the hardware, this sequence cannot be influenced by a program run which takes place in the arithmetic unit and it can be started up independently of the program run in the arithmetic unit.

In one development there is provision for the circuit to be configured and/or the arithmetic unit to be configured to control the sleep mode and/or to switch off the power supply for the arithmetic unit as a function of detection of a dip in a supply voltage. In order to detect the dip in the supply voltage, the control and/or the switching off of the arithmetic unit are triggered by means of a characteristic of the time profile of the supply voltage, for example by means of the downward transgression of a threshold value. A dip in the supply voltage occurs if the supply voltage drops at least temporarily below a reference voltage. Such an undervoltage may significantly reduce the reliability of the arithmetic unit in this context or completely prevent a functional capability of the arithmetic unit.

In addition to the detection of the dip in the supply voltage, it is also advantageously possible to trigger further results such as a control instruction of a central control unit of the motor vehicle, control of the sleep mode and/or switching off of the power supply of the arithmetic unit. In one advantageous embodiment there is provision for the arithmetic unit to be designed to change over from the sleep mode into an operating mode in such a way that it can be woken up. The power supply preferably has an electrical power store such as for example, a capacitor or an accumulator which is connected to the power supply. The power store can advantageously be charged via a connection to the voltage supply here.

In one advantageous embodiment, a capacitor is provided for buffering the power supply of the control device during a dip in the supply voltage. According to another preferred embodiment of the invention, a measuring means is provided for measuring the supply voltage and for determining a dip in the supply voltage. The measuring means preferably has an analogue/digital converter. According to a further embodiment, the measuring means has a low-pass filter for filtering the measured supply voltage.

In one preferred development, the circuit is configured to transmit the control data from the volatile memory into the nonvolatile memory as a function of detection of a dip in the supply voltage. The detection of the dip in the supply voltage is advantageously carried out here with the previously mentioned means. The transmission is triggered here, for example, by an external signal, via a signal pulse or by a bit sequence which is preferably output by the microcontroller.

According to one preferred development there is provision for the circuit to have a hard-wired transistor logic for transmitting the control data from the volatile memory into the nonvolatile memory. Owing to its hard wiring, the transistor logic cannot be programmed. The transistor logic has, for example, a gate, a signal memory, a shift register and/or other standard cells which each have a number of transistors for forming their respective function.

In one embodiment of this development, the transistor logic is designed to bring about the transmission of the control data as a function of a signal at least one signal input. Although further dependences on other signals are possible, OR operations are preferably carried out on the dependencies among one another so that the transmission inevitably takes place when the signal is applied to the signal input. The transmission is advantageously impossible for the program run of the arithmetic unit to abort here so that undefined states of the arithmetic unit do not lead to a loss of data. The signal serves here to trigger the transmission, which preferably takes place independently of a current state of a software run in the arithmetic unit.

According to one preferred development, fixed (nonvariable) addresses in the volatile memory and/or in the nonvolatile memory are assigned to the control data. The assignment is preferably permanently defined here by wiring of the hardware. A first address component of the volatile memory is preferably assigned to a second address component of the nonvolatile memory. If control data or other data is already contained in the second address component of the nonvolatile memory before the transmission, this data is advantageously overwritten during the transmission in the nonvolatile memory. The program run in the arithmetic unit is preferably designed here to continuously write the control data to be stored into the first address component of the volatile memory and therefore to update it.

In one preferred development, the volatile memory and the nonvolatile memory have a parallel interface which can be controlled by the circuit. The parallel interface preferably permits parallel transmission of at least one byte of the control data. The parallel interface is preferably of bidirectional design here, with the direction of the transmission between the volatile and the nonvolatile memory being preferably capable of being controlled by the transistor logic. The control of the parallel interface is advantageously characterized by what are referred to as tristates per bit.

The circuit, the volatile memory and the nonvolatile memory are preferably integrated onto a single semiconductor chip. The arithmetic unit is advantageously integrated onto a further semiconductor chip and the two semiconductor chips are arranged inside a component housing and are connected in particular by means of bonding wires.

Furthermore, the object on which the invention is based is achieved by means of an adjustment device for a motor vehicle. This adjustment device has an adjustment mechanism, a drive motor and the previously explained control device. The control device is connected here to the drive motor in order to control a drive current. The control device is designed to acquire the control data from the drive current and/or a sensed movement of the drive motor. Furthermore, the control device is designed to control the drive current as a function of the control data.

A further object on which the invention is based is to specify a further developed method for controlling a functional unit of a motor vehicle. This method object is achieved by means of a control method.

In a method for controlling a functional unit of a motor vehicle, control data is advantageously determined continuously during operation of the functional unit. In one operating mode, the functional unit is controlled by an arithmetic unit as a function of the control data.

If a dip in a supply voltage is determined, the arithmetic unit is placed in a sleep mode and/or disconnected from a power supply as a function of the determination of the dip in the supply voltage. The control data is transmitted from a volatile memory into a nonvolatile memory while the arithmetic unit is placed in the sleep mode and/or the arithmetic unit is disconnected from the power supply.

In a preferred embodiment, after the dip in the supply voltage, the arithmetic unit is changed back into the operating mode. For this purpose, the control data which is transmitted into the nonvolatile memory is mirrored into the volatile memory.

In a first embodiment variant, the control data is mirrored here by means of the arithmetic unit. According to a second embodiment variant, the control data is mirrored independently of a program run of the arithmetic unit, preferably during the transfer into the operating mode.

According to one preferred development of the invention there is provision that, before the sleep mode or before the switching off of the power supply, a clock frequency is reduced for a program run of the arithmetic unit in order to reduce the power draw of the arithmetic unit. In a further development there is provision that, before the sleep mode or the switching off of the power supply, further electrical loads which are connected to the power supply are de-energized. Such electrical loads are, for example, sensors, for example Hall sensors and, if appropriate actuators, heating elements or displays. This permits a power drain due to the connected loads which can be adapted to a drop in the supply voltage so that after only brief drops in the supply voltage the full operational capability of the control device is resumed more quickly.

In one development, the arithmetic unit is placed in the sleep mode and/or disconnected from the power supply after the supply voltage has dropped below a first threshold value. A second threshold value is preferably provided so that, after the supply voltage has dropped below the second threshold value, a program run of the arithmetic unit is interrupted, in order, in particular, to switch off the further loads or reduce the clock frequency. In this context, the second threshold value is advantageously above the first threshold value so that the supply voltage firstly drops below the second threshold value during a dip and drops below the first threshold value if the supply voltage continues to drop.

### BRIEF DESCRIPTION OF DRAWINGS

FIG. 1 shows a schematic block circuit diagram of a control device.

FIG. 2 shows a schematic functional diagram of a control device.

FIG. 3 is a schematic illustration of a sequence which is implemented in a control device.

### DETAILED DESCRIPTION OF INVENTION

The invention will be explained in more detail below in an exemplary embodiment and with reference to a drawing. FIG. 1 illustrates a schematic block circuit diagram of a control device. The diagram shows an, in particular, integrated circuit 100. A measuring input of the circuit 100 is connected via a resistor R1 to a supply voltage U_{K}. The supply voltage connection which is connected to a motor vehicle battery is also referred to as terminal 30 in the motor vehicle (not illustrated in FIG. 1). The measuring input which is connected to the resistor R1 is connected to an analogue/digital converter 120 of the circuit 100 which can be formed, for example, from one or more comparators in order to measure and evaluate the supply voltage U_{K}.

Furthermore, an anode connection of a diode D1 is connected to the supply voltage U_{K}. A buffer capacitor C1 is connected to the cathode connection. The diode D1 and the buffer capacitor C1 form a power supply for the circuit 100 and are therefore also connected to the circuit 100. The charge which is stored in the buffer capacitor C1 is sufficient here to continue to operate the circuit 100 temporarily for a minimum time period even when there is a sudden drop in the supply voltage U_{K}. If the supply voltage U_{K} rises again, the buffer capacitor C1 is charged to a rated voltage of the power supply again.

The circuit 100 has an arithmetic unit 1000, which is embodied, for example as a microcontroller chip. A programmable program run, which permits a drive (not illustrated in FIG. 1) to be controlled, is implemented in this arithmetic unit 1000. This drive is coupled mechanically to a signal transmitter/sensor system which has a Hall sensor 200. This Hall sensor 200 is connected in turn to the circuit 100. The circuit 100 is designed here to switch off a power supply to the Hall sensor 200.

Furthermore, the circuit 100 has an input which is connected to the Hall sensor 200 and acts on an interrupt unit 130 (interrupt controller). This interrupt unit 130 of the circuit 100 is additionally connected in functional terms to the analogue/digital converter 120 and the arithmetic unit 1000 so that the Hall sensor 200 or the analogue/digital converter 120 can trigger an interrupt signal which influences a program run in the arithmetic unit 1000.

The arithmetic unit 1000 reads in control data and evaluates it for the control of the drive (not illustrated). For example, the sensor signal of the Hall sensor 200 is evaluated and an adjustment position and an adjustment speed are determined from this sensor signal. At least the last four current adjustment positions and the last four current adjustment speeds are stored continuously in a volatile memory RAM of the circuit 100. For this purpose, fixed memory addresses are reserved for this control data in the volatile memory RAM.

Likewise, a nonvolatile memory E²PROM, which, like the volatile memory RAM, is also connected to the arithmetic unit 1000, is provided in the circuit 100. Data which is not to be lost after the supply voltage has been switched off, for example as a result of a central key switch (not illustrated in FIG. 1) being turned, can be stored in the nonvolatile memory E²PROM by the arithmetic unit 1000. This data can be, for example, the latest current adjustment position or parameters which are specific to the electromechanical adjustment system.

Furthermore, the circuit 100 has a state generator 1500 (state machine). This state generator 1500 functions as a transmission circuit for transmitting control data from the volatile memory RAM into the nonvolatile memory E²PROM. The transmission of the control data by the state generator 1500 can be carried out here independently of the program run in the arithmetic unit 1000. The state generator 1500 is constructed here from a transistor logic and therefore cannot be programmed. When there is a trigger signal at its input, the state generator 1500 inevitably carries out a transmission sequence for transmitting the control data from the volatile memory RAM into the nonvolatile memory E²PROM.

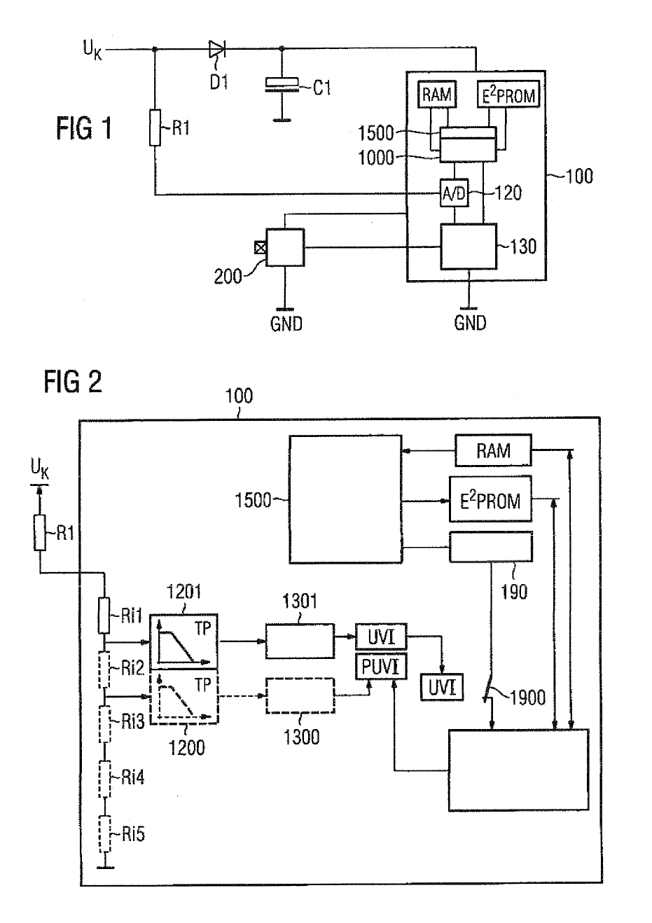

The method of functioning of the inevitably occurring transmission of the control data from the volatile memory RAM into the nonvolatile memory E²PROM is explained in more detail in FIG. 2. The supply voltage U_{K} and the resistor R1 which is connected to the circuit 100 are illustrated again for the sake of explanation. The internal resistors Ri1 to Ri5 of the circuit 100 form voltage dividers together with the resistor R1. Taps on these voltage dividers are connected to a first low-pass filter 1201 and a second low-pass filter 1200.

The first low-pass filter 1201 is functionally connected to a first interrupt unit 1301, and the second low-pass filter 1200 is functionally connected to a second interrupt unit 1300, which interrupt units 1301, 1300 can, for example, also be formed from the same components in the circuit 100. The low-pass filter 1200 causes voltage dips in the supply voltage U_{K} which are shorter than a parameterizable time period to be filtered out here. These voltage dips therefore do not cause an interrupt signal PUVI to be triggered (pre-under-voltage-interrupt).

However, if the voltage drops for a period which is longer than the parameterizable time period, a pre-under-voltage interrupt signal PUVI is first triggered. This pre-under-voltage interrupt signal PUVI triggers an interrupt in the program run in the arithmetic unit 1000. Immediately afterwards, the arithmetic unit 1000 carries out actions for reducing the power draw from the power supply 190.

In a time between the pre-under-voltage interrupt signal PUVI and the interrupt signal UVI (under-voltage-interrupt) the control data in the volatile memory RAM is advantageously updated by the microcontroller 1000. The microcontroller 1000 preferably has an additional internal volatile memory (not illustrated in FIG. 1). For the purpose of updating, the control data is advantageously copied from the internal volatile memory of the microcontroller 1000 into the volatile memory RAM. Furthermore, the microcontroller 1000 preferably has what is referred to as a flash and/or what is referred to as a ROM (read-only memory) for a software application, for example for the control process.

Voltage dips in the supply voltage U_{K} which drop below a parameterizable threshold voltage of, for example, 6.0 volts, firstly generate the pre-under-voltage interrupt signal PUVI which acts on the arithmetic unit 1000 and its program run. As a result of this action, loads which are connected, for example, to a power supply 190 and are therefore connected in parallel with the arithmetic unit 1000, the loads being for example the Hall sensor 200 (in FIG. 1), are switched off by the arithmetic unit 1000.

Furthermore, the clocking of the arithmetic unit 1000 can be reduced with the effect that the power drain from the power supply 190 is reduced. A program run in the arithmetic unit 1000 is ensured for a minimum time period of a few milliseconds by the power supply 190. The power supply 190 can be formed here, for example, by a buffer capacitor (C1) and a diode (D1), as in FIG. 1. Furthermore, the arithmetic unit can subsequently change into a sleep mode in which it can be woken up.

If the supply voltage U_{K} continues to drop, an interrupt signal (under-voltage-interrupt) is generated after the voltage drops below a threshold value, the interrupt signal acting on a switch 1900 in such a way that the arithmetic unit 1000 is abruptly disconnected from the power supply 190 and the arithmetic unit 1000 no longer draws any current from the power supply 190. Furthermore, the same interrupt signal UVI acts via an input of the state generator 1500 on the transistor logic of the state generator 1500, which transistor logic inevitably causes the control data to be transmitted from the volatile memory RAM into the nonvolatile memory E²PROM. For this purpose, the state generator 1500 draws the necessary energy from the power supply 190, which advantageously has a sufficient residual charge for this in the buffer capacitor C1. During the transmission of the control data by the state generator 1500 the arithmetic unit 1000 is disconnected from the power supply 190.

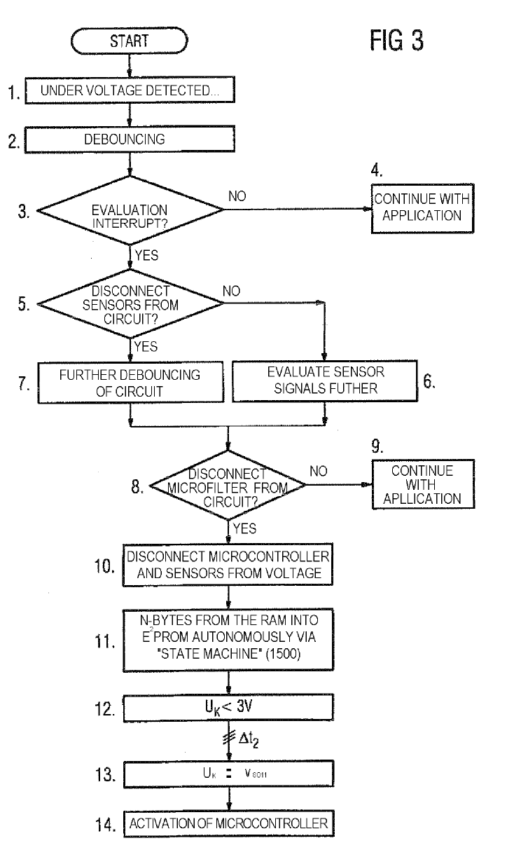

A sequence which is implemented in the circuit 100 is illustrated schematically as a flow chart in FIG. 3. After the start of the operating mode of the control device, an undervoltage of the supply voltage U_{K} can be detected in step 1 at any time during the ongoing operation. In step 2, debouncing of the measured signal is carried out, for example, by means of a low-pass filter in order to prevent incorrect triggering. The undervoltage event is then evaluated in step 3 and it is decided whether an interrupt signal (interrupt) is triggered. If no interrupt is triggered, the application, for example the automatic closing of the windowpane, is continued by the control device in step 4.

If an interrupt is triggered in step 4, in step 5 it is decided whether sensors, for example Hall sensors (200) are disconnected from the circuit in order to prevent their power drain from the power supply (190). If the sensors are disconnected from the circuit, the supply voltage U_{K} is debounced once more in step 7. Otherwise, the sensor signals are evaluated further in step 6.

Then, in step 8 it is checked whether the arithmetic unit (1000) which is embodied as a microcontroller μC is to be disconnected from the power supply (190). If disconnection does not take place, the application is continued in step 9. Otherwise, in step 10 both the microcontroller μC (1000) and the sensors (200) are disconnected from the power supply (190). In addition, what is referred to as the state machine 1500 is triggered so that in step 11 it autonomously copies control data, for example 8 bytes, from the volatile memory (RAM) into the nonvolatile memory (E²PROM).

In step 12, the supply voltage has then already dropped below 3V. After a nonspecific time interval Δt_{L}, the supply voltage U_{K} reaches a reference voltage U_{Soll} again in step 13, with the result that in step 14 the microcontroller μC is activated again and the application can, if appropriate, be continued.

What is claimed is:

1. A control device for an adjustment mechanism of a motor vehicle, the control device comprising
an arithmetic unit that is configured to control a function unit of the motor vehicle,
a volatile memory for storing control data, wherein the volatile memory is connected to the arithmetic unit for storing the control data,
a non-volatile memory, and
a circuit,
wherein the circuit and/or the arithmetic unit are designed to place the arithmetic unit in a sleep mode and/or to switch off a power supply for the arithmetic unit, and the circuit is configured to transmit the control data from the volatile memory into the nonvolatile memory in a sleep mode or in a switched-off state of the arithmetic unit.

2. The control device according to claim 1, wherein the circuit or the arithmetic unit is configured, or both are configured, to control the sleep mode as a function of detection of a dip in a supply voltage and/or to switch off a power supply for the arithmetic unit.

3. The control device according to claim 1, further comprising a capacitor for buffering a power supply of the control device during a dip in a supply voltage.

4. The control device according to claim 1, further comprising a measuring means for measuring a supply voltage and determining a dip in the supply voltage.

5. The control device according to claim 4, further comprising a low-pass filter for filtering the measured supply voltage.

6. The control device according to claim 1, wherein the circuit is configured to transmit the control data from the volatile memory into the nonvolatile memory as a function of detection of a dip in a supply voltage.

7. The control device according to claim 1, wherein the circuit has a hard-wired transistor logic for transmitting the control data from the volatile memory into the nonvolatile memory.

8. The control device according to claim 7, wherein the transistor logic is designed to bring about the transmission of the control data as a function of a signal of at least one signal input.

9. The control device according to claim 1, wherein the control data is assigned a plurality of nonvariable addresses in the volatile memory and a plurality of nonvariable addresses in the nonvolatile memory.

10. The control device according to claim 1, wherein the volatile memory and the nonvolatile memory have a parallel interface that can be controlled by the circuit.

11. The control device according to claim 1, wherein the arithmetic unit is designed to change over from the sleep mode into an operating mode in such a way that it can be woken up.

12. The control device according to claim 1, wherein the circuit, the volatile memory, and the nonvolatile memory are integrated onto a single semiconductor chip.

13. The control device according to claim 11, wherein the arithmetic unit is integrated onto a second semiconductor chip, and wherein the two semiconductor chips are arranged inside a component housing and are connected by bonding wires.

14. An adjustment device for a window-lifting system of a motor vehicle, the adjustment system comprising
an adjustment mechanism,
a drive motor, and
a control device connected to the drive motor in order to control a drive current, wherein the control device is designed to acquire control data from the drive current and a sensed movement of the drive motor, and wherein the control device is designed to control the drive current as a function of the control data.

15. A method for controlling a functional unit of a motor vehicle, comprising
receiving control data,
controlling the functional unit as a function of the control data by means of an arithmetic unit,
determining a dip in a supply voltage,
placing the arithmetic unit in a sleep mode or disconnecting the arithmetic unit from a power supply as a function of the determination of the dip in the supply voltage, and
transmitting the control data from a volatile memory into a nonvolatile memory while the arithmetic unit is placed in the sleep mode or disconnected from the power supply.

16. The method according to claim 15, further comprising
transferring the arithmetic unit for control purposes to the operating mode after the dip in the supply voltage, and
mirroring the control data, transmitted into the nonvolatile memory, for control purposes in the volatile memory.

17. The method according to claim 16, wherein mirroring the control data is achieved by using the arithmetic unit.

18. The method according to claim 16, wherein mirroring the control data comprises mirroring the control data independently of a program run of the arithmetic unit during the transfer into the operating mode.

19. The method according to claim 15, further comprising reducing a clock frequency for a program run of the arithmetic unit, before placing the arithmetic unit in the sleep mode or disconnecting the arithmetic unit from the power supply.

20. The method according to claim 19, further comprising de-energizing at least one load that is connected to the power supply, before placing the arithmetic unit in the sleep mode or disconnecting the arithmetic unit from the power supply, wherein the at least one load is selected from the group consisting of a sensor, an actuator, a heating element, or a display.

21. The method according to claim 15, further comprising placing the arithmetic unit in the sleep mode or disconnecting the arithmetic unit from the power supply, after the supply voltage drops below a first threshold value.

22. The method according to claim 15, further comprising interrupting a program run of the arithmetic unit, after the power supply has dropped below a second threshold value, in order, to switch off at least one load or to reduce the clock frequency.
